(19) United States
(12) Patent Application Publication
(10) Pub. No.: US 2018/0066468 A1
(43) Pub. Date: Mar. 8, 2018

(54) ANTI-RATTLE ELEMENTS FOR INTERNAL DIVIDER OF GLASS ASSEMBLY

(71) Applicant: Pella Corporation, Pella, IA (US)

(72) Inventors: Howard C. Anderson, III, Tracy, IA (US); Paul Smith, Des Moines, IA (US)

(21) Appl. No.: 15/694,285

(22) Filed: Sep. 1, 2017

Related U.S. Application Data
(60) Provisional application No. 62/383,034, filed on Sep. 2, 2016.

(51) Int. Cl. E06B 3/66

(52) U.S. Cl. CPC E06B 3/6604; E06B 3/6612

(57) ABSTRACT

An insulated glass assembly includes a first pane of translucent, obscure, or transparent sheet material, a second pane of translucent, obscure, or transparent sheet material spaced apart from the first pane, a perimeter spacer positioned between the first and second panes and extending around the perimeter of the panes, and an internal divider disposed between the first and second spaced apart panes. The internal divider is spaced from the first pane and second panes of sheet material to form a first gap and a second gap therebetween. The insulated glass assembly further includes a first spring element and a second element within the gaps between the internal divider and the first and second spaced apart panes. The first spring element and the second element combine to bias the internal divider against contact with either of the first and second spaced apart panes.

### CROSS REFERENCE TO RELATED APPLICATION

The present application claims benefit to Provisional Patent Application Ser. No. 62/383,034, filed on Sep. 2, 2016 and titled ANTI-RATTLE ELEMENTS FOR INTERNAL DIVIDER OF GLASS ASSEMBLY, the entire disclosure of which is hereby incorporated by reference herein.

### TECHNICAL FIELD

The present invention relates to windows and doors for use in buildings.

### BACKGROUND

A true divided light window or door is very attractive and popular for use in homes, but is very expensive as individual panes of glass must be assembled into an insulated glass assembly for a window or door. Alternatively, external grids may simplify window or door construction, but are difficult to clean and may be fragile if a thin grid design is used.

Internal grids of muntin bars may be positioned between the spaced apart panes of glass of an insulated glass assembly. In contrast to external grids, internal grids may not collect dust or dirt and allow the panes of glass to be readily cleaned. However, the use of internal grids may also cause other issues. For example, the use of internal metal muntin bars may cause heat loss through the metal bars. In addition, spacers to constrain muntin bars between panes of glass can produce stress points in glass, and during very cold weather, breakage has occurred as the panes contracted towards each other. Undesirable rattling may also occur with internal grids from contact between the muntin bars and panes, for example, during high winds.

### SUMMARY

As described herein, spring elements may be positioned between panes of an insulated glass assembly and an internal divider disposed between the panes. The spring elements may bias the internal divider against contact with either of the first and second spaced apart panes.

In one example, this disclosure is directed to an insulated glass assembly includes a first pane of translucent, obscure, or transparent sheet material, a second pane of translucent, obscure, or transparent sheet material spaced apart from the first pane of sheet material, a perimeter spacer positioned between the first and second panes and extending around the perimeter of the panes and defining two pairs of opposite sides of the glass assembly, and an internal divider disposed between the first and second spaced apart panes. The internal divider is spaced from the first pane of sheet material to form a first gap therebetween, and the internal divider is spaced from the second pane of sheet material to form a second gap therebetween. The insulated glass assembly further includes a first spring element within the first gap between the internal divider and the first pane of sheet material, and a second element within the second gap between the internal divider and the second pane of sheet material. The first spring element and the second element combine to bias the internal divider against contact with either of the first and second spaced apart panes.

While multiple examples are disclosed, still other examples of the present disclosure will become apparent to those skilled in the art from the following detailed description, which shows and describes illustrative examples of this disclosure. Accordingly, the drawings and detailed description are to be regarded as illustrative in nature and not restrictive.

### BRIEF DESCRIPTION OF THE DRAWINGS

FIGS. 1A-1C illustrate components of an insulated glass assembly including spring elements between a grill and glass panes.

FIGS. 2A-2H illustrate alternative spring elements to those of FIGS. 1A-1C.

FIG. 3 is a close-up view of a single set of spring elements within an insulated glass assembly having a tubular design.

FIGS. 4A-4H illustrate alternative spring elements to those of FIG. 3.

FIG. 5 is a close-up view of a single set of spring elements within an insulated glass assembly having a coil design.

FIGS. 6A-6C illustrate alternative spring elements to those of FIG. 5.

### DETAILED DESCRIPTION

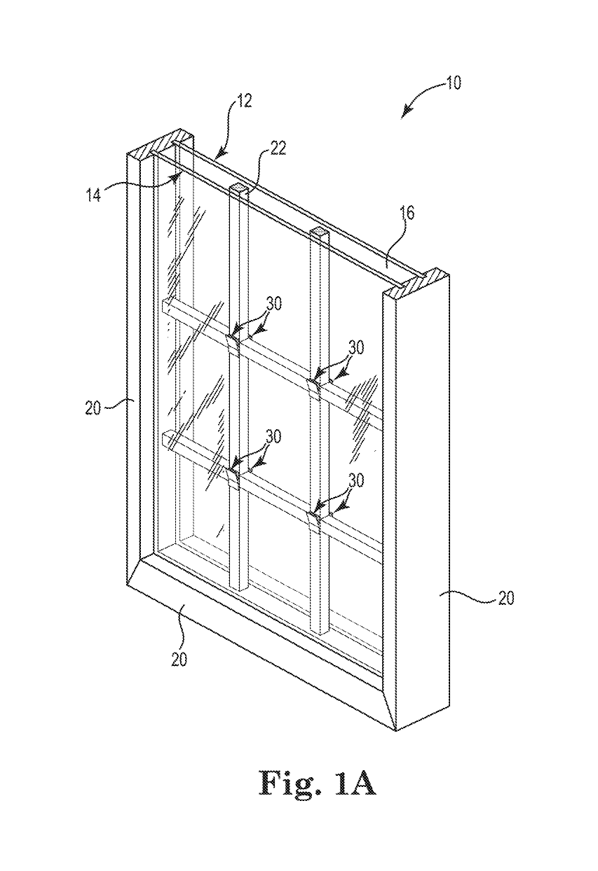

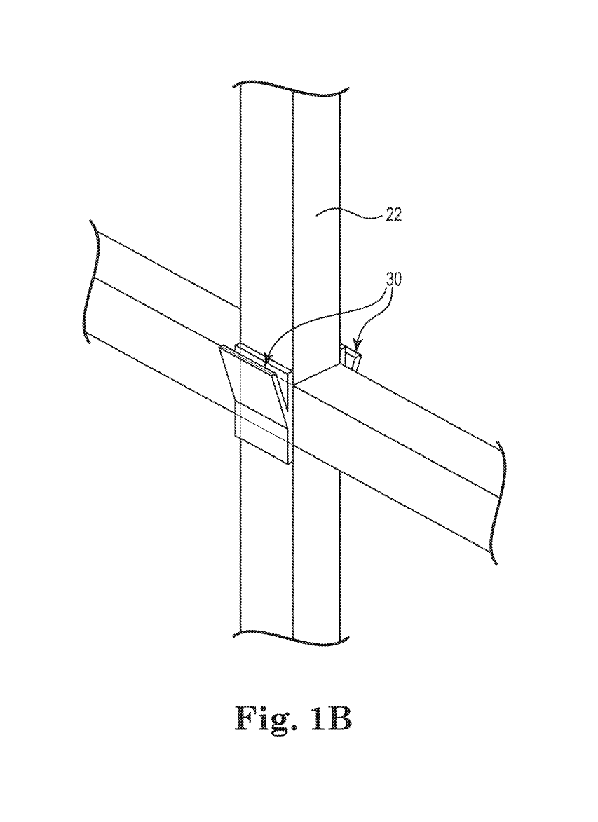

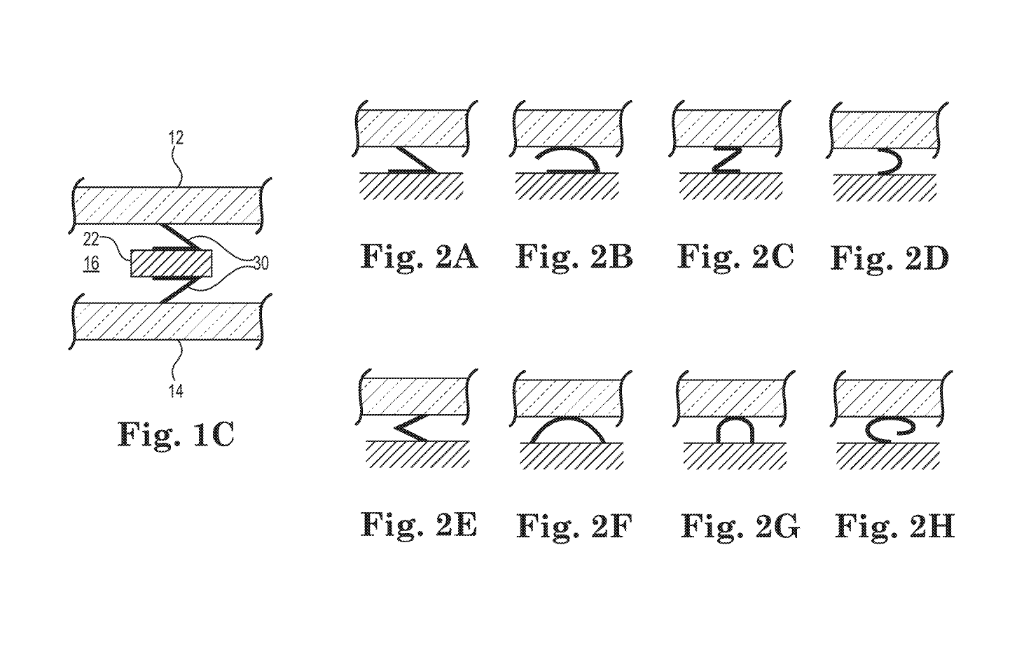

FIG. 1A illustrate a cut-away view of insulated glass assembly 10, which is a component of a window, such as a component of a window sash, or a component of a door. Insulated glass assembly 10 includes a first pane 12 of translucent, obscure, or transparent sheet material, a second pane 14 of translucent, obscure, or transparent sheet material, the second pane 14 of sheet material being spaced apart from the first pane 12 of sheet material to form a gap 16 there between, and a perimeter spacer 20 positioned between the first and second panes 12, 14 and extending around the perimeter of the panes 12, 14.

Insulated glass assembly 10 further includes an internal divider 22 disposed between the first and second spaced apart panes 12, 14 within gap 16. In various examples, the internal divider 22 may include a bar, a hollow, a rod, a channel, a solid shape, a grill between glass (GBG), a simulated divided light (SDL) spacer tube, and a shade bar. The internal divider 22 is spaced from the first pane 12 to form a first gap therebetween, and is spaced from the second pane 14 to form a second gap therebetween.

Spring elements 30 are located within the first gap between the internal divider 22 and the first pane 12 and within the second gap between the internal divider 22 and the second pane 14. In the example of FIG. 1A, spring elements 30 are positioned on either side of intersections of vertical and horizontal elements of internal divider 22. Such an arrangement may provide suitable support for internal divider 22 while limiting the visual perceptibility of spring elements 30, although other arrangements of spring elements and internal divider 22 may also be used. Spring elements 30 may be formed from a transparent material to reduce their visual perceptibility. In the same or different examples, spring elements 30 also may be formed from an outgassing resistant material to reduce their impact on the internal environment of insulated glass assembly.

Internal divider 22 may be formed from a material low in thermal conductivity, such as a foam material to limit heat transfer between panes 12, 14. Likewise, spring elements 30 may be formed from low thermal conductivity materials, such as a polymeric material to limit heat transfer between panes 12, 14. In addition contact surface area between spring elements 30 and panes 12, 14 may be limited to further mitigate heat transfer between panes 12, 14.

FIG. 1B illustrates internal divider 22 and a single spring element 30, which is representative of one or more of spring elements 30 of FIG. 1A. As shown in FIG. 1B, spring element 30 is a flexible, clear material folded to create a leaf spring is adhered on the internal divider 22.

FIG. 1C illustrates a close-up view of a single set of spring elements 30A, 30B, which are representative of one or more of spring elements 30 of FIG. 1A. Spring elements 30A, 30B space internal divider 22 within gap 16 between panes 12, 14. The first spring element 30A and the second spring element 30B combine to bias the internal divider 22 against contact with either of the first pane of sheet material 12 or the second pane of sheet material 14.

The pair of spring elements 30A, 30B are on opposite sides of internal divider 22, and the height of a spring element 30 may be sufficient to touch the adjacent pane. The pair of spring elements 30A, 30B may bias the internal divider 22 against contact with either of the adjacent panes 12, 14. The pair of spring elements 30A, 30B are on opposite sides of internal divider 22 and may function to keep internal divider 22 approximately centered within gap 16 between panes 11, 12. The pair of spring elements 30A, 30B may also prevent internal divider 22 from hitting either of the first and second spaced apart panes, 11, 12, when the panes 11, 12 and/or internal divider 22 vibrate, due to wind, or other agitation such as an external impact. The pair of spring elements 30A, 30B may prevent also internal divider 22 from hitting either of the first and second spaced apart panes, 11, 12, from hitting either of the first and second spaced apart panes, 11, 12, when insulated glass assembly 10 experiences fluctuations in gap 16 between the first and second spaced apart panes due to changing environmental conditions.

Spring elements 30 each represent a leaf spring that elastically deforms when compressed. In the example depicted in FIGS. 1A-1C, the leaf spring includes a bent polymeric sheet material, with one side of the sheet material secured to the internal divider 22.

In other examples, one of spring elements 30 may be replace with a bumper. In such examples, the bumper may maintain a spacing between internal divider 22 and the adjacent one of panes 12, 14. A spring element 30 may maintain a spacing between internal divider 22 and the other one of panes 12, 14. In such examples, the single spring element 30 may allow changing spacing between panes 12, 14, e.g., due to vibrations or changing environmental conditions, whereas the bumper simply maintains a less adaptable spacing between internal divider 22 and the adjacent one of panes 12, 14. In this manner, spring elements 30 on only a single side of internal divider 22 may combine with less flexible bumpers to maintain spacing between internal divider 22 and panes 12, 14 while also limiting stress concentrations due to changing spacing between panes 12, 14.

FIGS. 2A-2H illustrate alternative leaf spring elements between a pane and a bar. The leaf spring elements of FIGS. 2A-214 may be used in place of spring elements 30 as described with respect to FIGS. 1A-1C. In various examples different spring element configurations may be used for the spring elements within a single glass assembly 10 or the same spring element configuration be used for each of the spring elements within a single glass assembly 10.

In the example, of FIG. 2A the leaf spring element is the same spring elements 30 as depicted in FIGS. 1A-1C. The leaf spring element of FIG. 2A includes a folded polymeric sheet material, with one side of the sheet material secured to the internal divider 22. Similarly, the leaf spring element of FIG. 2B includes a folded sheet material, with one side of the sheet material secured to the internal divider 22, but the free side of the folded polymeric sheet material is curved such that a convex surface of the spring element contacts the pane. The leaf spring element of FIG. 2C includes a twice-folded sheet material to form a Z-shape, with one side of the sheet material secured to the internal divider 22 and the other parallel side of the Z-shape in contact with the pane.

The leaf spring element of FIG. 2D includes a twice-folded sheet material to form a M-shape, with one side of the sheet material secured to the internal divider 22 and the other parallel side of the M-shape in contact with the pane. The center of the M-shape provides a continuous curve configuration. Similarly, the leaf spring element of FIG. 2E includes a 3-fold sheet material to form a M-shape, with one side of the sheet material secured to the internal divider 22 and the other parallel side of the M-shape in contact with the pane. In contrast with the leaf spring element of FIG. 2D, the center of the M-shape of the leaf spring element of FIG. 2E includes a distinct fold.

The leaf spring element of FIG. 2F forms a C-shape, with the ends of the sheet material secured to the internal divider 22 and the curved side of the C-shape in contact with the pane. Similarly, the leaf spring element of FIG. 2G forms an extended C-shape, with the ends of the sheet material secured to the internal divider 22 and extending about perpendicular to the internal divider 22 with the curved side of the C-shape in contact with the pane. In an alternative configuration, the leaf spring element of FIG. 2H forms a C-shape, with the ends of the sheet material pointing towards one another and secured to the internal divider 22 and extending about perpendicular to the internal divider 22 and the curved side of the C-shape in contact with the pane.

While the examples of 2A-2H are each described as being secured to the internal divider 22, in other examples, such leaf spring element configurations may be adhered to the pane or simply compressed between the internal divider 22 and the pane to maintain their positions within an insulated glass assembly. In the same or different examples, internal divider 22 may include complimentary features, such as snap fit elements, to engage a leaf spring element such that active adhesion techniques are not required.

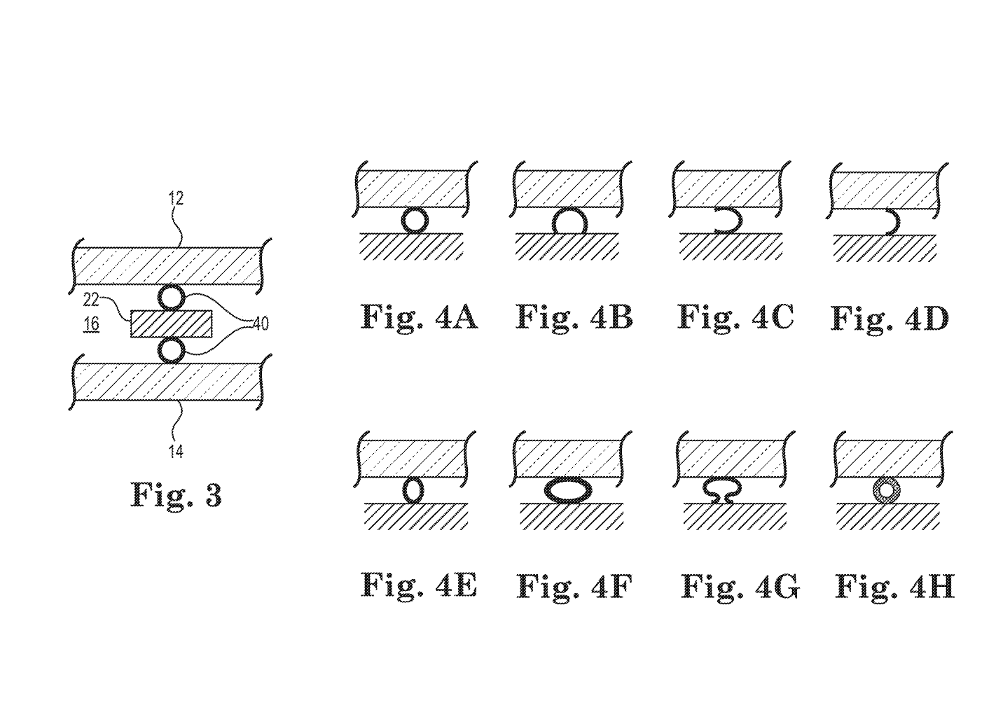

FIG. 3 is a close-up view of a single set of spring elements 40 within a window sash. As shown spring elements 40 are have a tubular design formed from a tubular, flexible material. Spring elements 40 may be used in place of one or more of spring elements 30 of FIG. 1A to space internal divider 22 within gap 16 between panes 12, 14. Spring elements 40 combine to bias the internal divider 22 against contact with either of the first pane of sheet material 12 or the second pane of sheet material 14.

The height of a spring element 40 may be sufficient to touch the adjacent pane 12 or pane 14 and bias the internal divider 22 against contact with the adjacent pane. The pair of spring elements 40 are on opposite sides of internal divider 22 and may function in the manner described with respect to spring elements 30 to keep internal divider 22 approximately centered within gap 16 between panes 11, 12 and prevent internal divider 22 from hitting either of the first and second spaced apart panes, 11, 12. Spring elements 40 each represent a tubular spring element that elastically deforms when compressed.

FIGS. 4A-4H illustrate alternative spring elements formed from a tubular, flexible material similar to that of FIG. 3. The spring elements of FIGS. 4A-4H may be used in place of leaf spring elements 30 as described with respect to FIGS. 1A-1C. In various examples different spring element configurations may be used for the spring elements within a single glass assembly 10 or the same spring element configuration be used for each of the spring elements within a single glass assembly 10.

In the example of FIG. 4A, the spring element is the same spring elements 40 as depicted in FIG. 3. The spring element of FIG. 4A includes a tubular, flexible material, such as a polymeric material, and one side of the tubular material may be secured to the internal divider 22.

The spring element of FIG. 2B includes a cut tubular material, with one side of the material secured to the internal divider 22, but the free side of the cut tubular material is curved such that a convex surface of the spring element contacts the pane. The spring element of FIG. 4C also includes a cut tubular material, with the cut side facing away from both the pane and the internal divider 22 rather than towards the internal divider 22 as with the spring element of FIG. 4B.

In the example of FIG. 4D, the spring element includes about half of a longitudinally bisected tubular material, although in other examples more or less than half of a longitudinally split tubular material may be used instead.

In the examples of FIGS. 4E and 4F, the spring element includes an oblong tubular material, with the major axis of the oblong tubular material being oriented about perpendicularly to the pane in the example of FIG. 4E and about parallel to the pane in the example FIG. 4F.

In the example of FIG. 4G, the spring element includes a cut tubular material with the ends of the cut material bent outwardly and secured to the internal divider 22.

In the example of FIG. 4H, the spring element includes a tubular material of thicker construction than that previously depicted. The thickness of the tubular material may be selected in combination with the material of the spring element to provide a desired level of spring force.

While the examples of 4A-4H are each described as being secured to the internal divider 22, in other examples, such configurations may be adhered to the pane or simply compressed between the internal divider 22 and the pane to maintain their positions within an insulated glass assembly. In the same or different examples, internal divider 22 may include complimentary features, such as snap fit elements, to engage a spring element such that active adhesion techniques are not required.

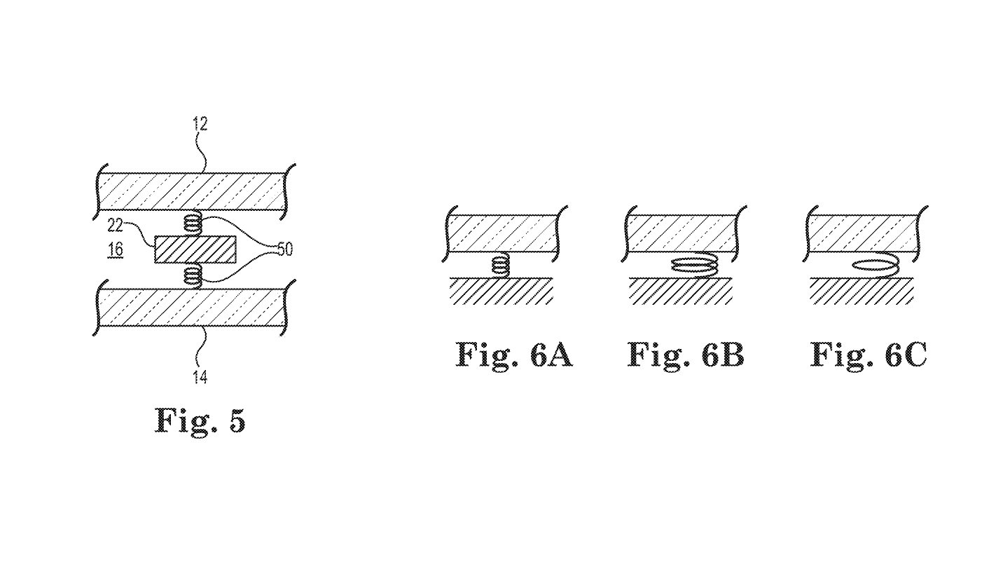

FIG. 5 is a close-up view of a single set of spring elements 50 within a window sash. As shown spring elements 50 having a coiled construction, such as a helical coil. Spring elements 50 may be used in place of one or more of spring elements 30 of FIG. 1A to space internal divider 22 within gap 16 between panes 12, 14. Spring elements 50 combine to bias the internal divider 22 against contact with either of the first pane of sheet material 12 or the second pane of sheet material 14.

The height of a spring element 50 may be sufficient to touch the adjacent pane 12 or pane 14 and bias the internal divider 22 against contact with the adjacent pane. The pair of spring elements 50 are on opposite sides of internal divider 22 and may function in the manner described with respect to spring elements 30 to keep internal divider 22 approximately centered within gap 16 between panes 11, 12 and prevent internal divider 22 from hitting either of the first and second spaced apart panes, 11, 12. Spring elements 50 each represent a coil spring element that elastically deforms when compressed.

FIGS. 6A-6C illustrate alternative spring elements formed from coil similar to that of FIG. 5. The spring elements of FIGS. 6A-6C may be used in place of leaf spring elements 30 as described with respect to FIGS. 1A-1C. In various examples different spring element configurations may be used for the spring elements within a single glass assembly 10 or the same spring element configuration be used for each of the spring elements within a single glass assembly 10.

In the example of FIG. 6A, the spring element is the same spring elements 50 as depicted in FIG. 3. The spring element of FIG. 6A includes coil of a diameter that is smaller than the distance between the pane and the internal divider 22. In contrast, the spring element of FIG. 6B includes coil of a diameter that is larger than the distance between the pane and the internal divider 22. The spring element of FIG. 6B includes coil of a diameter that about equal to the distance between the pane and the internal divider 22.

Internal divider 22 may include complimentary features, such as snap fit elements, to engage a spring element such that active adhesion techniques are not required. Alternatively, the spring elements of FIGS. 6A-6C may be adhered to internal divider 22 or simply compressed between the pane and internal divider 22.

While multiple examples are disclosed, still other examples within the scope of the present disclosure will become apparent to those skilled in the art from the detailed description provided herein, which shows and describes illustrative examples. Accordingly, the drawings and detailed description are to be regarded as illustrative in nature and not restrictive. Features and modifications of the various examples are discussed herein and shown in the drawings. While multiple examples are disclosed, still other examples of the present disclosure will become apparent to those skilled in the art from the following detailed description, which shows and describes illustrative examples of this disclosure.

What is claimed is:

1. An insulated glass assembly comprising:
a first pane of translucent, obscure, or transparent sheet material;
a second pane of translucent, obscure, or transparent sheet material spaced apart from the first pane of sheet material;
a perimeter spacer positioned between the first and second panes and extending around the perimeter of the panes and defining two pairs of opposite sides of the glass assembly;
an internal divider disposed between the first and second spaced apart panes, wherein the internal divider is spaced from the first pane of sheet material to form a first gap therebetween, and the internal divider is spaced from the second pane of sheet material to form a second gap therebetween;
a first spring element within the first gap between the internal divider and the first pane of sheet material; and
a second element within the second gap between the internal divider and the second pane of sheet material,
wherein the first spring element and the second element combine to bias the internal divider against contact with either of the first and second spaced apart panes.

2. The insulated glass assembly of claim 1, wherein the second element is a second spring element.

3. The insulated glass assembly of claim 1, wherein the second element is a bumper.

4. The insulated glass assembly of claim 1, wherein the internal divider includes at least one of:
a bar,
a hollow;
a rod;
a channel;
a solid shape;
a grill between glass (GBG);
a simulated divided light (SDL) spacer tube; and
a shade bar.

5. The insulated glass assembly of claim 1, wherein the first spring element and the second element combine to bias the internal divider to be about centered between the first and second spaced apart panes.

6. The insulated glass assembly of claim 1, wherein the first spring element includes a first leaf spring, and wherein the second element includes a second leaf spring.

7. The insulated glass assembly of claim 1, wherein the first spring element includes a tubular, flexible material.

8. The insulated glass assembly of claim 1, wherein the first spring element includes a coil spring.

9. The insulated glass assembly of claim 1, wherein the first spring element and the second element are configured to prevent the internal divider from contacting with either of the first and second spaced apart panes when the insulated glass assembly experiences an external impact.

10. The insulated glass assembly of claim 1, wherein the first spring element and the second element are configured to prevent the internal divider from contacting with either of the first and second spaced apart panes when the insulated glass assembly experiences fluctuations in the space between the first and second spaced apart panes due to changing environmental conditions.

11. The insulated glass assembly of claim 1, wherein the internal divider is formed from a material low in thermal conductivity to limit heat transfer between the first and second spaced apart panes.

12. The insulated glass assembly of claim 1, wherein the first spring element is formed from low thermal conductivity materials to limit heat transfer between the first and second spaced apart panes.

13. The insulated glass assembly of claim 1, wherein the first spring element and the second element are secured to opposing sides of the internal divider.

14. The insulated glass assembly of claim 1, wherein the first spring element is formed from a polymeric material.

15. The insulated glass assembly of claim 1, wherein the first spring element is formed from a transparent material.

16. The insulated glass assembly of claim 1, wherein the first spring element is formed from an outgassing resistant material.

17. The insulated glass assembly of claim 1, wherein the first and second panes are panes of transparent sheet material.

18. The insulated glass assembly of claim 1, wherein the insulated glass assembly is a component of a door.

19. The insulated glass assembly of claim 1, wherein the insulated glass assembly is a component of a window.

20. The insulated glass assembly of claim 1, wherein the insulated glass assembly is a component of a window sash.
